(19) United States
(12) Patent Application Publication
(10) Pub. No.: US 2021/0225049 A1
(43) Pub. Date: Jul. 22, 2021

(54) Perceptual Rasterization for Image Rendering

(71) Applicant: UCL Business Ltd, London (GB)

(72) Inventors: Tobias Ritschel, London (GB); Anthony Steed, London (GB); Sebastian Friston, London (GB)

(21) Appl. No.: 15/734,041

(22) PCT Filed: May 31, 2019
(86) PCT No.: PCT/GB2019/051520

§ 371 Date: Dec. 1, 2020

(30) Foreign Application Priority Data
Jun. 7, 2018 (GB) 1809387.2

(51) Int. Cl. G06T 11/40; G06F 3/01; G06T 3/40; G09G 5/37; G06T 11/20

(52) U.S. Cl. CPC G06T 11/40; G06F 3/013; G06T 3/40; G09G 5/37; G09G 2320/0261; G09G 2340/0428; G09G 2340/045; G09G 2354/00; G06T 2210/12; G06T 11/203

(57) ABSTRACT

A method for rasterizing part of an image for a display, the image comprising one or more primitives, the method comprising for a first primitive in the image: calculating a distortion of the primitive, said distortion dependent on a determination of how the primitive will be perceived by a user when displayed on a display; distorting the primitive based on the calculation of the distortion to define a distorted primitive; defining a new primitive to be rendered by: bounding the distorted primitive with a polygon; and defining the new primitive based on the intersection of pixels from both the first primitive and the polygon of the distorted primitive.

### TECHNICAL FIELD

The present disclosure relates to a system and method for rendering images on a display. In particular, but not exclusively, the system and method are used for head mounted displays.

### BACKGROUND

In many contexts, graphics, or images, are most usually rendered by a device incorporating a GPU as part of an image processing pipeline. GPUs are found, and used, in multiple devices such as mobile devices, head mounted displays (HMDs), personal computers, games consoles etc.

In the case of displays such as HMDs, they have requirements beyond those of typical desktop display-based systems. The HMD and system driving it must maintain low and predictable latency to facilitate a sense of agency and avoid serious negative consequences such as breaks-in-presence, simulator sickness, and reduced performance. Further characteristics typical of HMDs, and other types of display, include a high field of view (FOV) and high resolution for regions of the foveal vision of the user.

It is known in the art to use ray-tracing in such displays. Ray-tracing can cast more rays to the foveal area (foveation) and update the view parameters during image generation (low latency). However, ray-tracing is processing intensive and typically remains too slow in large and dynamic scenes. It is also known to use rasterization to render images. Traditional rasterization efficiently draws an image, but with uniform sampling. It does not take advantage of how that image will be perceived.

As is known for GPUs, the GPU will calculate and render the primitives that form an image. The use of polygons, straight lines, or planar geometry, when rendering primitives allows for the GPUs to effectively calculate and render an image. GPUs by their nature are able to render finite straight line elements, such as polygons, effectively.

A further aspect which affects how an image is rendered, and perceived, in displays is the length of time, or interval [tₛ, tₑ], that a pixel is displayed. The longer the interval, the more “outdated” a stimulus will become: if each pixel holds a constant value for 1/60 of a second, at the end of the interval tₑ the image may deviate significantly from the ideal representation of the state of the virtual world. Where a scene shows a significant amount of motion, and/or on combination with head or eye motion, this interval may lead to hold-type blur of the image. It is also known in some displays to render the displayed image as a “global scan” where the entire display is illuminated at once, however such techniques may result in flickering which is similarly undesirable.

As such there is a desire to be able to render images, in particular but not limited to, on HMDs which account for the display and GPU, as well as the user's perception of the image.

### SUMMARY OF THE INVENTION

Aspects and embodiments of the invention provide a system and method for perceptual rasterization as claimed in the appended claims.

According to an aspect of the invention there is provided a method for rasterizing part of an image for a display, the image comprising one or more primitives, the method comprising for a first primitive in the image: calculating a distortion of the primitive, said distortion dependent on a determination of how the primitive will be perceived by a user when displayed on a display; distorting the primitive based on the calculation of the distortion to define a distorted primitive; defining a new primitive to be rendered by: bounding the distorted primitive with a polygon; and defining the new primitive based on the intersection of pixels from both the first primitive and the polygon of the distorted primitive.

Such a process allows for a single pass perceptual rasterization process where the end user's perception of the image is taken into account to allow the image to be rendered in a manner which lowers the computational requirement without a perceived drop in quality for the user.

Optionally the method further comprising the step of rasterizing the new primitive on a display.

Optionally the calculation of the distortion is based in part on the perceived foveation of the image by the user. Optionally wherein the method further comprises: determining a gaze position for a user's eye; determining a location of the primitive relative to the gaze position and calculating the distortion of the primitive based on the location of the primitive relative to the gaze position. Optionally wherein the resolution of pixels which form the first primitive is increased towards the fixation point and decreased away from the gaze position. Optionally wherein the distortion of the primitive comprises magnifying, or demagnifying, pixels which form the first primitive.

By decreasing the resolution at the periphery of the image the computational cost is reduced whilst the user's perception of the image is unchanged, as the user's eyes resolution is lower in these regions and the user is therefore unable to perceive the drop in resolution.

Optionally wherein the bounding of the distorted primitive comprises the steps of: for each edge of the original primitive defining a bounding edge parallel to the original edge of the primitive; defining a maximum displacement from the original edge of the primitive to the corresponding edge of the distorted primitive; defining the bounding edge at the maximum displacement and joining each defined bounding edge to define the bounded distorted primitive. Optionally wherein the bounding of the distorted primitive comprises the steps of: for each edge of the original primitive determining the resultant vertices of the edge as a result of the foveation-based distortion and defining a bounding edge between the resultant vertices; defining a maximum displacement from bounding edge between the resultant vertices to the corresponding edge of the distorted primitive; defining the bounding edge at the maximum displacement and joining each defined bounding edge to define the bounded distorted primitive.

Such bounding techniques are found to be computationally efficient thereby lowering the overall cost of the pipeline.

Optionally wherein the calculation of the distortion is based in part on the motion of the primitive as a result of the time taken to render a display. Thus the effects of the scan out has on the user are also taken into account.

Optionally wherein for the first primitive further comprising the steps of: determining for a plurality of vertices of the primitive a first position at a first time; determining for a plurality of vertices of the primitive a second position at a second time; determining the distortion of the first primitive based on the motion of the vertices between the first and second time. Optionally wherein the first time is the start time at which the primitive is first rendered and the second time is the end time at which the primitive is rendered. Optionally wherein the motion of the vertices between the first and second position is linearly interpolated.

Thus the effects of the time taken to scan out, or render, an image and the user's perception as a result, are taken into account to more effectively render the image.

Optionally, wherein the step of distorting the primitive further comprises: bounding the distorted primitive with a polygon based on the position of the plurality of vertices at the first and second time. Optionally, wherein the bounding is based on defining a bounding box for all vertices. Optionally, wherein the bounding of the distorted primitive is based on a convex hull bounding. Optionally, wherein the bounding further comprises; determining a maximum time a pixel is displayed; defining the second time as the maximum time the pixel is displayed; and bounding the convex hull over the defined time interval.

Optionally wherein the bounding of the distorted primitive comprises the steps of for each of a plurality of edges of the primitive: defining a distortion to the edge due to motion of primitive to create a rolling edge; defining a distortion to the rolling edge due to the distortion of the foveation of the image to define a joint rolling foveated edge; bounding the joint rolling foveated edges to define the distorted primitive.

Bounding in such a manner is found to be computationally efficient thereby lowering the overall cost of the pipeline.

There is also provided a system for rasterizing part of an image on a display, the system comprising: a display for rendering an image; and a processor configured to execute any of the above recited method steps. Optionally further comprising an eye tracking device configured to determine a gaze position of a user's eye. Optionally wherein the display is one of a head mounted display an augmented reality display or a display associated with a mobile telephone.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic representation of the apparatus according to an aspect of the invention;

FIG. 2 is a flow chart of the process of a perceptual rasterization pipeline according to an aspect of the invention;

FIG. 3 is an example of a primitive;

FIG. 4 is an example of the primitive being distorted due to perceptual rasterization;

FIG. 5 is a flow chart of the process of foveation rasterization;

FIG. 6 is a flow chart of the process for amending a primitive based on the rolling properties of the display;

FIG. 7 is an example of bounding of a primitive for foveation distortion;

FIG. 8 is an example of bounding of a primitive for rolling distortion;

FIG. 9 an example of bounding of a primitive for joint rolling and foveation distortion;

FIG. 10 is a flowchart of the process of determining bounds for joint rolling and foveation distortion; and

FIG. 11 is a flowchart of the process for rasterizing shadow maps or reflective shadow maps.

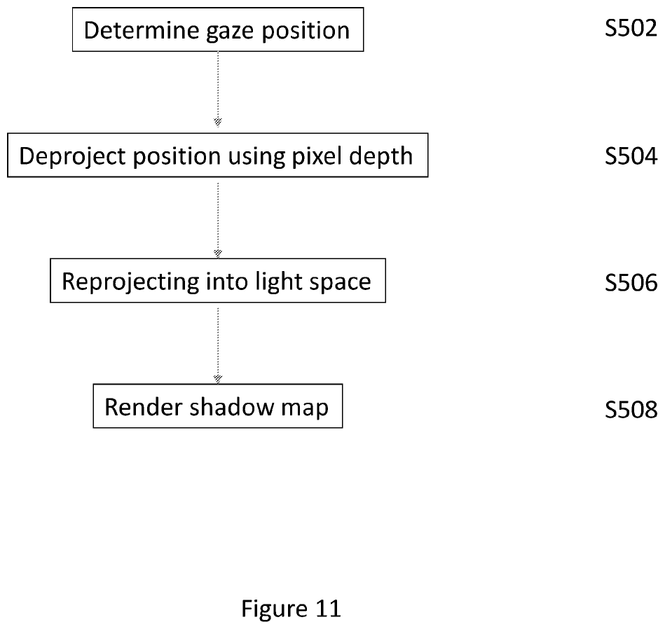

### DETAILED DESCRIPTION

The present invention provides a system and method for rendering images in displays. In particular, but not exclusively, the present invention may be used in head mounted displays (HMDs) where issues regarding latency and field of view are more prevalent. The present invention may be used in all types of displays, in particular where foveated and/or rolling imaging is used. Such displays include augmented reality displays and those found on mobile devices, tablet computers, portable computers etc.

The invention disclosed herein relates to a perceptual rasterization pipeline. As explained in detail below perceptual rasterization is the process of adapting an image, or parts of an image, based on how the image will be perceived by the end user and rasterising the adapted, or distorted, image.

In one example the image is adapted according to where the user's eyes are fixated to produce a foveated image. Foveated imaging is a known technique in which a gaze position/fixation point, or region, is determined and the resolution of the image within the region is increased to take advantage of the increased resolution of the human eye within that region. Further techniques for the foveation of the image also exist and are used in further embodiments.

In a further example, where the image is rendered on a display which renders the image over a finite interval of time, the image is adapted to take into account the motion of the image over the finite interval of time. By adapting the image to account for the latency, as would be perceived by the user, the user will perceive less blur and/or flickering.

In a further example the image is rendered on the display to take into account both the foveation and latency of the image.

In all examples, an aspect of the invention is to provide an improved rendering and rasterization method which allows for the image to be adapted and rendered in a manner which takes into account a user's perception of the image, whilst maintaining the speed and effective processing attained by rasterization.

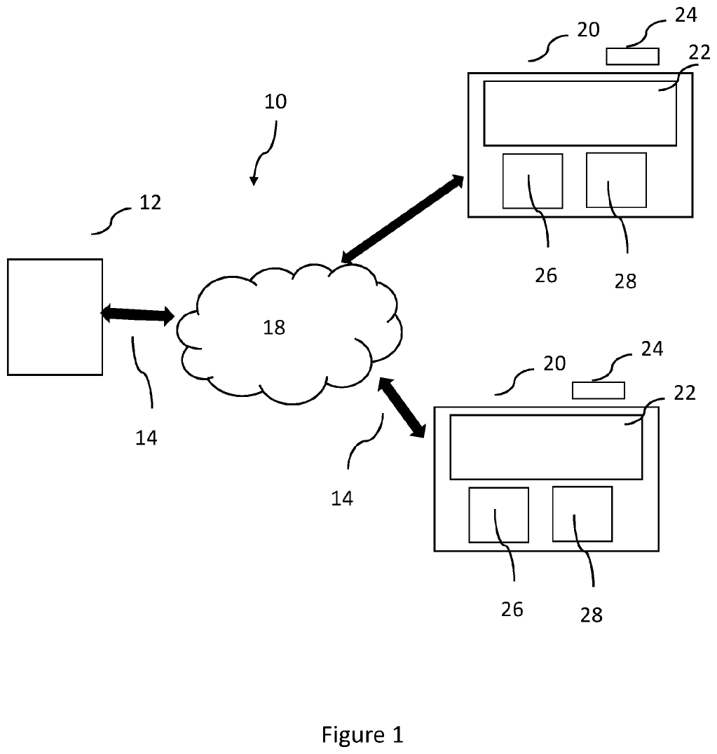

FIG. 1 is a schematic representation of the system for implementing the perceptual rasterization pipeline in accordance with an embodiment of the invention. Whilst FIG. 1 is shown with reference to a computer with a head mounted display (HMD) in further embodiments other forms of display and computing devices may be used, such as mobile devices.

In FIG. 1 there is shown a system 10 for performing an example of the perceptual rasterization method. The system 10 comprises a streaming server 12 which is arranged to deliver image data 14 via a data stream 16 over a network 18, such as data network, to one or more computing devices 20, each computing device 20 enabled to perform the perceptual rasterization method described herein.

The streaming server 12 can be any suitable data storage and delivery server which is able to deliver encoded data to the computing devices 20 over the network 18. Streaming servers 12 are well known in the art, and may use unicast and multicast protocols.

The computing devices 20 can be any suitable device such as tablet computers, laptop computers, desktop computers, video conferencing suite etc.

The network 18 can be any type of data network suitable for connecting two or more computing devices together, such as a local area network or a wide area network, and can include terrestrial wireless and wired connections, and satellite connections. The data network 18 may also be or include telecommunications networks, and in particular telecommunications networks that provide cellular data coverage. It is expected that the data network 18 would include the Internet, and connections thereto.

The computing device 20 comprises a display 22 which is connected to, or integrated within, the computing device 20. In an embodiment the display 22 is a head mounted display (HMD). In further embodiments the display 22 is another form of display such as a desk mounted LED, OLED display, stereo display etc.

The computing device 20 further comprises, or is associated with an eye tracking device 24. The eye tracking device is a known device configured to determine the point of gaze of a user, such devices are commercially available. The computing device 20 further comprises a known graphics processing unit (GPU) 26, and processor 28. The processor 28 is configured to execute the perceptual rasterization method described herein.

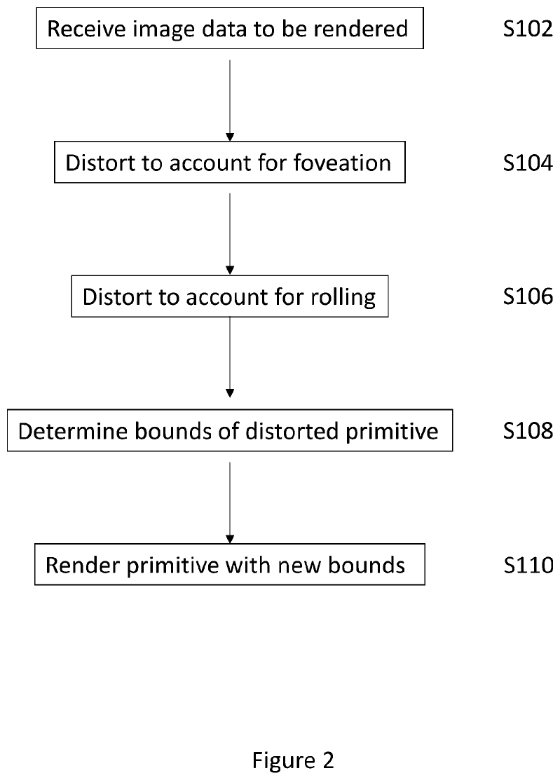

FIG. 2 is a flow chart of the process of perceptual rasterization according to an aspect of the invention.

At step S102 the image to be displayed on the display 22 is received at the computing device 20.

As described with respect to FIG. 1 the image may come from an external source, such a streaming server 12, or stored on a memory associated with the computing device 20. The computing device 20 comprises a known GPU 26.

The present methodology defines a single pass perceptual rasterization pipeline to allow the primitives to be rasterised in a more efficient manner. In an example, the image received is generated in a known manner which produces the image at a fixed time with a constant pixel density. As is known in rasterization the image is defined, and rendered, as a number of primitives. Each primitive is a polygon, or line segment, with straight lines.

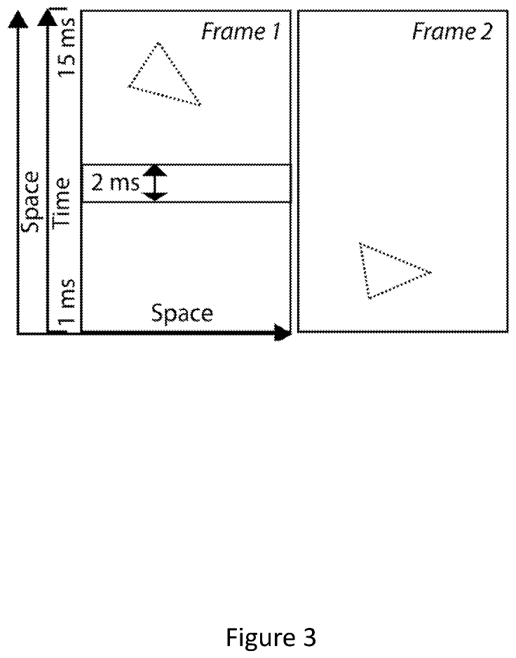

FIG. 3 shows an example of an image 202 to be rendered, and for ease of understanding a single primitive 204 is shown. The primitive is shown at a position in the first frame, and a second position in a second frame.

As is known in graphics rendering, the primitive is a polygon, or straight line element. The polygon comprises three or more straight edges.

In an embodiment, the image 202 is rendered on the display 22 in a rolling scan manner. The term “rolling” is chosen as an analogy to a camera's rolling shutter sensor, where the entire rendering of the image will take a finite amount of time. A classic CRT display is an example of a rolling scan display. This is in contrast to some LCD displays which provide a global synchronised illumination of all the pixels at once. Each pixel will also be illuminated for a finite period of time, known as the hold time.

The perceptual rasterization process, and described in detail below, requires the distortion of parts of the image, so that they are perceived in a different manner by the user (or example, a particular section is displayed at a higher resolution). This distortion causes the line segments and the straight lines of the polygons which define the primitives to become curved. GPUs 26 are however less able to process curved lines thus requiring further steps in the pipeline to render the primitive with straight lines. As described below the perceptual rasterization process will distort the primitive in order to account for foveation and/or the rolling properties of the display, as described above.

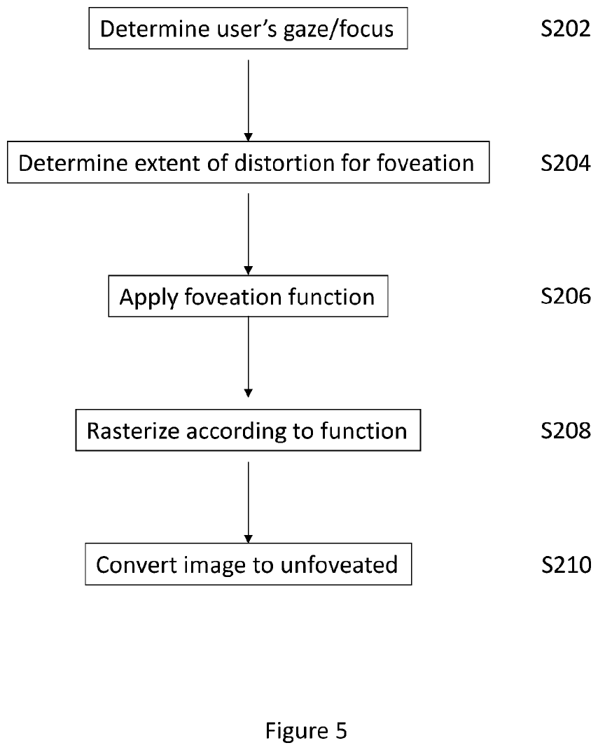

At step S104 the image is distorted to account for the user's perception due to the effect of foveation. That is to say the regions of the image which coincide with the user's foveal region are shown at an increased resolution to take into account the higher resolution of the human eye in this region. Furthermore, by taking into account the lower resolution of the human eye outside of the fovea computational savings may be made rendering the image is in these regions at a lower resolution. Importantly as the user's resolution in the peripheral regions is lower the user does not perceive the drop in resolution of the image. The process of distorting for foveation is described in more detail with respect to FIG. 5.

In summary at step S104 the image is displayed at a non-constant pixel density with the part of the image which is identified as being located at the user's foveal region having a higher resolution. In an embodiment the pixels that are in the foveated region are magnified, which pixels outside of the foveated region demagnified, with the extent of the demagnification being dependent on the distance of the pixels from the foveated region.

Preferably the non-uniform pixel density varies with the amount of magnification decreasing the further away the pixel is from the gaze position/fixation point.

In an embodiment the system utilises a known eye tracking device 24 in order to determine where the user's eyes are fixated i.e. the fixation point of the eye, and this region becomes the foveated region. As such the location of the fixation point, or gaze position, will vary over time. Such embodiments are particularly effective in HMDs where the user's fixation can be effectively determined.

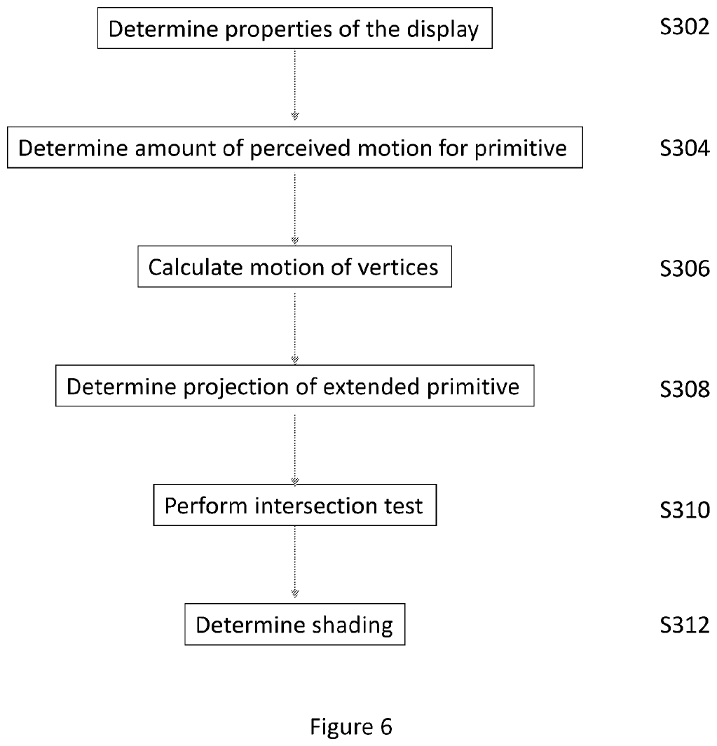

At step S106 the amount of distortion of the primitive, as perceived by the user, due to rolling is determined. Rolling describes the movement of the primitive over the timescale it takes for the display to render the image. The process of determining the distortion due to the finite time taken to render/scan out the image and motion of the primitive is described in detail with reference to FIG. 6.

In summary at step S106 a linear interpolation of the movement of the primitive is determined over the timescale at which the image is drawn and held before the next image is drawn. Such motion and time may cause the user to perceive the primitive in an extended form, with blurred or juddered edges.

Whilst in FIG. 2 the steps of determining a distortion to account for perceptual foveation and rolling motion occur consecutively, in further embodiments only one of foveation or rolling occur. That is to say either step S104 or S106 is skipped. In further embodiments the order in which the steps occur is reversed, or they occur concurrently.

As a result of the distortion to account for the user's perception at steps S104 and S106 the shape of the primitive changes, becoming distorted, or elongated. Such a distortion of the primitive results in primitives, or linear segments, having curved edges. GPUs are unable to effectively process and render curved edges, and as such in order to provide the image which has been altered to account for user perception, the bounds, or boundaries, of the primitives are redefined so as to recreate the distorted primitive with straight edges.

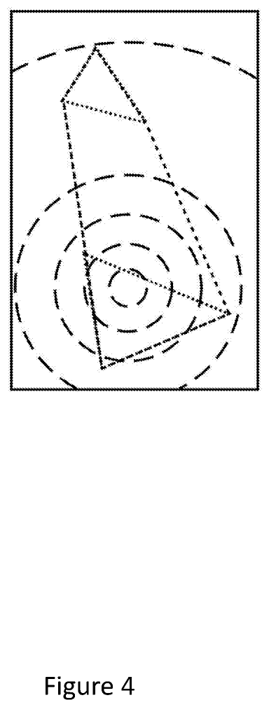

FIG. 4 is an exemplary representation of the primitive of FIG. 3 which has been distorted to account for the end user's perception as per steps S104 and S106.

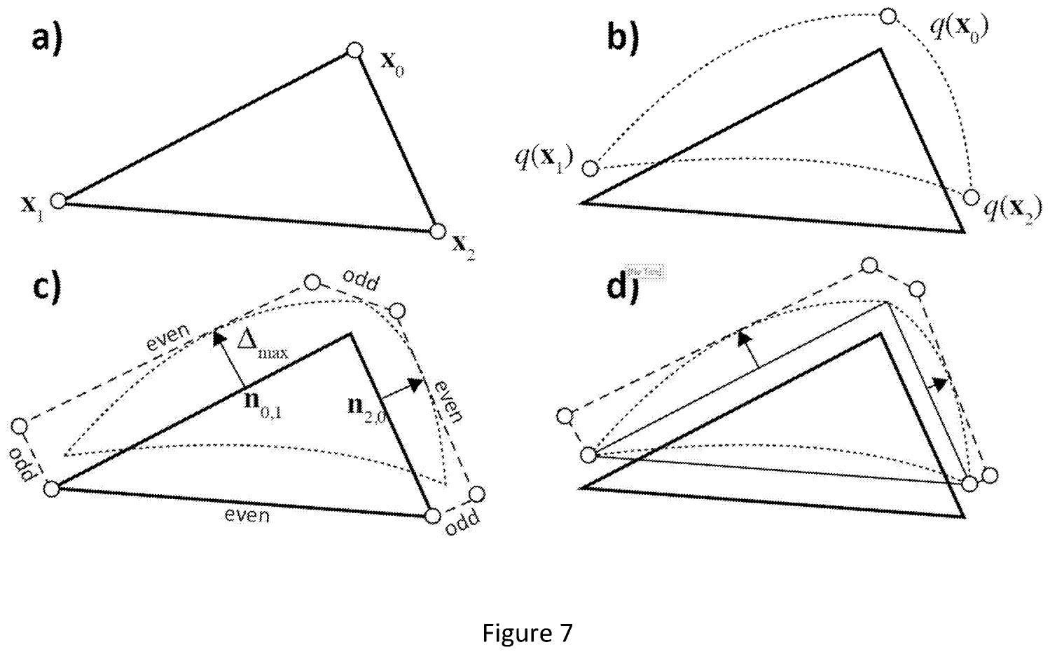

At step S108 the bounds of the distorted primitives are calculated and the distorted primitive redefined with straight lines. The process of determining the bounds is discussed in detail with reference to FIGS. 7 to 10. The bounds determined by step S108 result in tightly defined bounds which enable fast and efficient processing by a GPU.

In an embodiment, a simple bound is defined based on the maximum possible values of the boundary. In further embodiments a tighter bound is defined.

Once the bounds of the distorted primitive are determined, the pixels which are within the bound are tested, or compared, with the original primitive. As explained below, with respect to the bounding process, the subset of pixels which are within the bound are tested compared to the original primitive, and pixels which, when viewed by the user, intersect both the original primitive and the bound for the distorted primitive are rasterized.

At step S110 the image with the primitive bounds as determined in step S108 is rendered thus providing for a rasterised image which has been corrected according to the end user's perception of the image. Advantageously, the above described methodology allows for the perceptual imaging to occur in a single pass thus ensuring effective processing and rendering of the image.

By determining the amendments required to the individual primitives in the image, so as to best account for the end user's perception of the image, improvements regarding the image displayed can be made. Furthermore, given the constraints of modern displays, in terms of field-of-view and resolution, as well as the increased computational requirements of displays such as HMDs, the perceptual based imaging allows for a more computationally effective mechanism to display the image. Such amendments to the primitives may result in the primitive being defined in a sub-optimal manner for processing by GPUs. Thus in order to enable effective processing of the primitive by the GPU a new bound for the primitive is defined, said new bound being defined with straight lines to allow for effective processing by a GPU.

FIG. 5 is a flowchart of the process of foveating part of the image in order to account for the user's perception.

The process described with reference to FIG. 5 allows for perceptual rasterization based on the user's field of view to be implemented. As is known in foveated imaging, the human eye has a higher resolution at the gaze direction, or centre of the field of view, with the eye having a lower resolution at the edges. In order to take into account the user's perception of the image, the resolution of the image is increased towards the gaze direction and lowered at the periphery of the image. By reducing the resolution at the periphery of the image, where the eye has a lower resolution, the computational requirements are lowered without the user being able to perceive the drop in the resolution of the image.

As the process is based on the user's perception a determination of the gaze, or focus, of the user is made at step S202. In a preferred embodiment the determination of the gaze of the user is determined using the eye tracking device 24. Other suitable means for determining the eye gaze may also be used. Such determination of the user's gaze is known in the art.

At step S202 therefore a gaze position, or foveation point, is determined. This point is defined as x_{f}.

At step S204 in order to determine the extent of the distortion of the image required, a domain, or function is defined which models the distortion according to the gaze position. Therefore at step S204 the distortion to account for how the primitive would be perceived by a user is determined. Thus at step S204 computational savings can occur as the process increases the resolution of the image in the fovea region as well as decreasing the resolution in the periphery of the image, thus lowering the overall computational cost for generating and realising the image.

In an embodiment to retain the simplicity of rasterization on a regular grid, to give more importance to an area, it is simply magnified. So instead of increasing the pixel density in the fovea, the pixels are magnified.

In an embodiment, at step S204, an image domain is defined where the ray (or pixel) density depends on a function

p(d)∈(0,\sqrt{2})→ [symbol] ⁺

where d is the distance to the foveation point x_{f}. This function operates in normalised device coordinates. In further embodiments, where different coordinate spaces are used the function is changed accordingly. In contrast to common rasterization, where the function is a constant (i.e. there is no variation in density across the image) at step S204 a variation is shown. For foveated rendering, the variation is higher close to the fovea (i.e. where d is small) and lower than 1 for the periphery (d is large). Thus for displays such as HMDs with large fields of view, the resolution is decreased for areas which are at the periphery, where the user's vision also has a lower resolution. Thus perceptually the user will not perceive the decrease in resolution whilst reducing the computational requirement for the display. Advantageously by increasing the density towards the foveated region the user's perception of the image increases as the high density coincides with the region of the eye with the highest resolution. Thus the user will perceive an image of greater image quality with a minimum of increase in computational resource.

In equation 1 p can be any foveation function, such a physiologically based (Daniel and Whitteridge 1961) or empirically based (Weier et al. 2017; Patney et al. 2016). The size of the foveated region, and therefore p, must account for non-idealities such as imperfect tracking and suboptimal frame rates. These may also change over time. Therefore in an embodiment it is assumed that the function may have any suitable form, subject to the constraints below, and free to change every frame. In further embodiments the function remains constant for all frames.

Given p, a further function is defined

q(x)∈(−1,1)²→(−1,1)²:x_{f}+norm(x−x_{f})·p(∥x−x_{f}∥).

This function essentially scales x by p, away from the gaze position. Near the centre as determined at step S202, this function results in stretching, as the pixel density is larger than 1. In the periphery the function results in compression, as fewer pixels are required.

Additionally there is defined q⁻¹, to be q but with p⁻¹ in place of p. p⁻² is the inverse of pp.

Note that d is not a scaling factor but an exact distance. Thus pp maps an unfoveated distance to a foveated distance, and p⁻¹ maps it back. and q⁻¹ use these functions to do the same for pixel locations. We refer to these pixel transformations as to “foveate” and “unfoveate”. This necessitates that pp is invertible. Any monotonic p can be inverted numerically in a pre-processing pass, if an analytic inversion is non-trivial.

At step S206 each primitive in the image is rasterised according to the function defined in step S204.

At step S208 after rasterizing all primitives, the foveated image I_{f} is converted back into an unfoveated Iᵤ one for display. This imposes several challenges for filtering: q⁻¹ is heavily minifying in the center and heavily magnifying in the periphery. In an embodiment a MIP map for the foveated image is created at step S208. The MIP map is created in a known manner.

At step S210 the form of the displayed image is determined. At step S210 the MIP map is evaluated Iᵤ(x)=I_{f}(q⁻¹(x)) using proper tri-linear MIP mapping and a 3-tap cubic filter. A higher-quality version computes

$${L}_{d} ( x ) = {\sum }_{y ∈ 5 \times 5} {L}_{c} ( q ( x ) + y ) \cdot r ( ‖ x - {q}^{- 1} ( q ( x ) + y ) ) ‖ ) ,$$

where L_{d} is the display image, I_{c} the foveated imaged, and r an arbitrary, e. g., Gaussian, reconstruction filter parametrized by distances in the display image domain. Such an operation effectively computes the (irregular-shaped) projection of the display's reconstruction filter into the cortical domain.

In further embodiments other suitable forms of transform may be used.

As well as compensating for foveation the perceptual rasterization accounts for the properties of the display. As described above many displays, in particular those used in HMDs take a finite amount of time in which the pixels on the screen are illuminated. That is to say not all the pixels are illuminated simultaneously, resulting in a rolling shutter during the scan out of the image. Such a finite period of time may be of the order of hundreds of microseconds.

Accordingly, there is also provided a method to compensate for the effects of the time delay and time taken to render an image on a display. As detailed above the process can be performed in addition to, or separately from, the foveation process described above.

FIG. 6 is a flow chart of the process for amending a primitive based on the rolling properties of the display. The rendering process comprises two stages the image generation (in which the effects of the motion are determined and the primitives amended accordingly) and the scan out of the image on the display. The process described with regards to rolling rendering may be implemented on any suitable device with a rolling display, such as, but not limited to HMDs, augmented reality displays and mobile telephones.

At step S302 properties regarding the display, and the scan out of the image on the display are defined. In a preferred embodiment three properties are defined: rolling illumination, a short hold-time, and the absolute head pose at any point in the interval [tₛ, tₑ].

The rolling scan refers to the fact that different parts of the display are illuminated at different times.

In an embodiment the rolling function is formalized as r(x)∈(0,1)²→(0,1):x·d which that maps a (unit) spatial location x to a (unit) point in time at which the display will actually show it by means of a skew direction d. d depends on the properties of an individual display. For example d=(0,0.9) describes a display with a horizontal scanout in the direction of the x-axis and a (blank) sync period of 10% of the frame period. The rolling function defined above is normalised in screen space.

The short hold time refers to the property of the display where a pixel is visible for only a short time relative to the total refresh period. A CRT display is typical of this type, where the CRT phosphor has a decay that typically reduces brightness by a factor of 100 within one millisecond.

The head pose of the user will change over time. However as the timescales over which the process occurs (of the order of tens of milliseconds) the amount the head pose will vary will be small, due to the limitations of the human body. Accordingly, an acceptable approximation is that the model-view transformation can be linearly interpolated across the animation interval and that vertices move along linear paths during that time. It is found that due to the timescales involved the errors associated with such an assumption are small.

At step S304 for each primary the amount of distortion is determined. At step S304 the amount of perceived motion based on the properties defined at step S302 is calculated and the amended primitive defined to compensate for the perception of the primitive. Specifically the position of each vertex of the primitive at the start and end of the interval is determined and the primitive is defined by the start and end positions of each vertex.

The process of determining the amount of distortion, in an embodiment, comprises the step of calculating the vertex, geometry and fragment properties of the primitive.

At step S306 a vertex program (VP) is run to determine the vertices of the extended primitive. Input to the VP are the world-space vertex positions vₛ at the beginning and vₑ at the end of the frame interval. Additionally, the VP is provided two model-view-projection matrices Mₛ and Mₑ that hold the model and view matrices at the beginning and the end of the frame interval. The VP transforms both the start and the end vertex, each with the start and the end matrix (Mₛ vₛ and Mₑvₑ).

Once determined this information is passed to a geometry program (GP). In an embodiment no projection is required at step S306

At S308 the projection of the extended primitive (as defined at step S306) is determined. Thus at step S308 the step of image generation occurs. Input to the GP is the tuple of animated camera-space vertices S=(v_{s,0}, v_{e,0}, v_{s,1}, v_{e,1}, v_{s,2}, v_{e,2}) i. e., an animated camera space triangle. The GP bounds the projection of this space-time triangle with a 2D primitive, such that all pixels that would at any point in time be affected by the triangle are covered by the new bounding primitive B.

Once the information is determined the geometry program passes the space-time triangle on to a fragment program (FP) as (flat) attributes. Note, that in an embodiment the bounding primitive B is not passed on from the GP to the FP: It is only required as a proxy to determine the pixels to test directly against S (and not B) i. e., what pixels to rasterize.

At step S310 the fragment program then performs an intersection test. Thus the subset of pixels which form, or fall within, both the original primitive and the bound primitive are identified.

At step S310 the fragment program is now executed for every pixel i that could be affected by the primitive's bound. Note that this test is the same regardless of what bounding is used.

(The process of bounding is described below).

At step S310 to decide if the pixel xᵢ actually is affected by the space-time triangle (as defined at step S308) ray-primitive intersection techniques are used. A ray Rᵢ is intersected at the pixel with the triangle at time r(xᵢ). The entire triangle, its normals, texture coordinates and material information, were emitted as flat attributes from the GP, as per step S308. Note that R depends on the time as well: every pixel i has to ray-trace the scene at a different time following r. For foveation, Rᵢ is not formed by a pin-hole model but follows q (the foveation function). The joint model distributes rays according to r∘q. The position of the entire triangle at time r(xᵢ) is found by linear interpolation of the vertex motion. This results in a camera-space triangle Tᵢ, that can be intersected with Rᵢ using a 3D ray-triangle intersection test. If the test fails, nothing happens. If the test passes, the fragment is written with the actual z value of the intersection and with common z buffering enabled. This will resolve the correct (i. e., nearest to the viewer) fragment information. For every pixel there is a unique time and fovea location, and hence distances of multiple primitives mapping to that pixel are z-comparable. This helps enable perceptual rasterization when primitives are submitted in a streaming fashion in an arbitrary order. Thus at step S310 the subset of pixels within both the original primitive and the bounded amended primitive are identified for the scan out of the image.

At step S312 shading for the primitive is determined. Shading has to respect the ray-primitive model as well: the time at every pixel is different for the rolling and joint model, having the implication that parameters used for shading, such as light and eye position should also be rolling and differ per pixel. This again can be done by simple linear interpolation. Note that shading is not affected by foveation.

Where both foveation and rolling perceptual rasterization are implemented the distortion is the composition of r∘q(x) as defined above.

Thus the above methodology will result in the primitive having a different form to account for the perception of the primitive by the user. As described above, the change in the primitive results in the primitive having non-linear edges. Thus in order to effectively render the primitive new bounds for the primitive are defined.

The bounds are defined by perceptual rasterization techniques used (foveation, rolling and joint rolling and foveation).

Each bounding technique is described in turn below. Each bounding technique will take the distorted primitive and bound it using a polygon. As a polygon has straight edges it may be easily rendered by a GPU.

Foveation Bounding

Below is described the process of defining new bounds for foveated primitives. An example of a primitive is shown in FIG. 7.

In FIG. 7 there is shown four sample primitives. There is shown the initial form of the primitive 7a) and the amended form of the primitive 7b) as a result of the perceptual rasterization processes described above. As can be seen from FIG. 7a the primitive has a regular triangular shape. As shown in FIG. 7b) the amended primitive 7b) has an extended non-linear form, with curved edges. Furthermore the vertices of the primitive are displaced from the original primitive.

There is also shown a simple bounded form of the primitive 7c) and an advanced bound of the primitive 7d). The formation of the simple and advanced bounds is discussed in detail below.

In order to allow a GPU to effectively render the primitive for the perceptual rasterization a method for defining the bounds of the primitive.

In an embodiment the process for bounding utilizes q and q⁻¹ (the foveation functions described above). The bounding geometry generated will consist of a convex polygon with six vertices, and does not require a convex hull computation. Every even pair of vertices is produced by bounding a single edge of the original triangle. Every odd pair joins the start and end of a bounding edge produced from a primitive edge. The remaining task is then to bound a single triangle edge from x₀ to x₁. This is shown pictorially in FIG. 7 as primitives 7c) and 7d). Two bounds are derived, a simple and a tighter recursive bound. Each type of bounding is described in turn below. In an embodiment the bounds are determined at the computing device 20 which displays on the display 22. In further embodiments the bounds are determined at an external device, for example using a cloud based rendering program.

In an embodiment all the primitives are rendered using one of the techniques. In further embodiments the primitives are rendered using a mixture of techniques.

Simple bounds

Here, the bounding edge is assumed to be parallel to the original edge, the edge defined as the straight line between x₀ and x₁ (this is shown in FIG. 7 as bound 7c). For such primitives to be bound the maximal positive distance along the normal from the edge joining

x₀ and x₁ is determined. This is defined as

$${Δ}_{max} = {max}_{s ∈ ( 0 , 1 )} \{ Δ ( s ) = ( {η}_{s} ( s ) - {η}_{c } ( s ) ) \cdot n ( {η}_{s} ( 0 ) , {η}_{s} ( 1 ) ) \}$$

$${η}_{s} ( s ) = {x}_{0} + s ( {x}_{1} - {x}_{0} ) and {η}_{c} ( s ) = q ( {x}_{0} + s ( {x}_{1} - {x}_{0} ) ) ,$$

where n creates a direction orthogonal to the line between its two arguments (i.e. the original primitive and the distorted primitive). Thus the bounding edge is placed at the maximum normal distance (shown as n_{0,1} and n_{2,0} in FIG. 7c)). As the edge is at the maximum distance it will by definition bound both the original primitive and the distorted primitive. As the distance is a convex function, it can be minimized using a ternary search that converges to a pixel-precise result in log(n) steps, if n is the number of possible values, here, the number of pixels on the edge. Consequently, for a 4 k image example, bounding requires 3×2×log(4096)=96 multiply-adds and dot products per triangle at most, but typically much less as triangle edges are shorter. The process is continued for each edge of the primary to define the bound for the entire primary. As described above this define the “even” edges of the bound with the “odd” edges joining the even edges.

Tighter Recursive Bounds

Consider the original vertices x₀ and x₁ (as shown in FIG. 7, as primitive 7a) and the foveation q(x₀) and q(x₁) of these vertices (as the primitive 7b). While the simple bound displaces relative to the straight original edge from x₀ to x₁ (106) the new recursive bound will displace relative to the straight edge q(x₀) to q(x₁) (108). This is defined as:

ηₛ(s)=q(x₀)+s(q(x₁)−q(x₀))

This is possible, as the edge has to be straight, but not necessarily the “original” one (i.e. the edge in the original primitive 7a). The resulting bound is tighter, i. e., the bound for 7d) is smaller than 7c). Note, that the normal for a different straight edge is also different, as q is a nonlinear function: an edge joining a point close to the origin and a point farther from the origin will change its slope as both are scaled differently.

Rolling Bounds

The situation for rolling perceptual rasterization is different due to the nature of the perceptual rasterization.

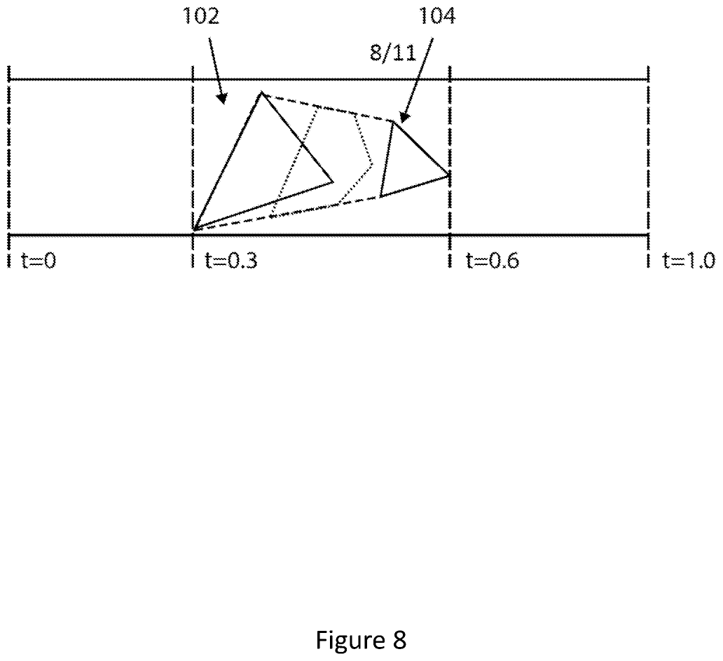

FIG. 8 shows an example of the rasterization bounds for a space-time triangle moving across the screen. In FIG. 8 the time axis (of an arbitrary time unit) is shown along the x axis. The triangle starts 102 at a position where the frame time already is 3 and ends 104 where frame time is 0.6.

Four bounds are defined below. Each bound may be used dependent on the need for accuracy versus computational simplicity.

As with the foveation bounds, the bounds may be determined at a processor associated with the computing device 20 at which the image is rendered, or an external device, accessed via a cloud service.

The types of bounds are boxes, or quads, 106, hull 108, adaptive 110 and Zenon 112 and shown FIG. 8. Each type of bound is described in turn below.

Boxes

Boxes are the simplest type of bound which can be defined for rolling rasterization. A reasonably tight bound for the time-space triangle S as defined in above, is the 2D bounding box (bbox)

B=bbox{ [symbol] (S_{i,j},t)|i∈{s,e}, j∈{0,1,2}, t∈{0,1}}

of all vertices in the start and end of the frame, where bbox builds the 2D bounding box of a set of points and [symbol] is the projection of a point at time t, i. e., multiplication with a time-varying matrix followed by a homogeneous division. This is also defined as a “Quad”. Thus the boxes bound simply draws a box around the outermost vertices of the primitive (which change position as a result of the rolling rasterization). The bound is therefore the simplest to calculate but the least accurate of the methods defined.

Convex Hull

As a bounding box may create substantial overdraw for thin and diagonal primitives it may produce less effective results. In some embodiments tighter bounding of the primitives is desired. Whilst the process described below is more computationally expensive, overall it may reduce the computational requirement as it reduces the amount of work done for each pixel.

The convex hull and the quick hull process for determining the bounds of the convex hull are known in the art, for example in the GLSL language.

As all points of a triangle under linear motion fall into the convex hull of its vertices the operator bbox (as defined above) can be replaced by the convex hull of a set hull that could be implemented efficiently for example using a GLSL quick hull implementation.

For primitives intersecting the near plane, all primitives completely outside the frustum are culled; primitives completely in front of the camera (but maybe not in the frustum) are kept, and those that intersect the near plane are split by this plane and their convex hull is used.

In an embodiment a convex hull of up to 15 points (as there are 15 edges between 6 space-time vertices) is used, resulting in higher overall performance than when using the simpler bounding box.

The convex hull method therefore provides an improved, tighter, bound albeit with a higher computational cost.

Adaptive Bounds

While convex hulls are tight spatially, the rolling case allows for a tighter bound under some simple and reasonable assumptions on the mapping from pixel locations to frame times. The key observation is that a rolling space-time triangle only has to cover

B=hull{ [symbol] (S_{i,j},t)|i∈{s,e}, j∈{0,1,2}, t∈{tₘᵢₙ,tₘₐₓ}},

where the triangle-specific time interval (tₘᵢₙ,tₘₐₓ) is found by mapping back 2D position to time

tₘᵢₙ=min{w⁻¹ [symbol] (S_{i,j},t)|i∈{s,e}, j∈{0,1,2}, t∈{0,1}}.

The maximal time tₘₐₓ is defined by replacing the minimum with a maximum operation. In other words, to bound, all six vertices are times 0 and 1, to get bounds in 2D and the maximal and minimal time at which these pixels would be relevant are determined. As this time span is usually shorter than the frame i. e., tₘᵢₙ>>tₛ and tₘₐₓ<<tₛ, the spatial bounds also get tighter.

Zenon's Hull Bound

In some embodiments, a limitation of the bounding occurs where the rolling scan will “catch up” with the projection of a moving triangle. Conceptually this limitation has similarity with Zenon's paradoxon where Achilles tries to catch up with the tortoise.

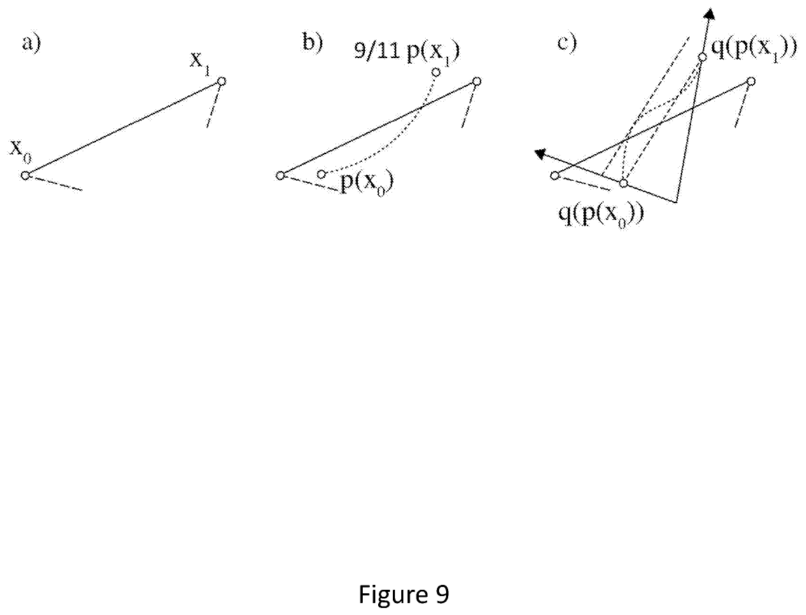

FIG. 9 is a graphical representation of the paradox with FIG. 9a showing how linearly over time Achilles catches up with the tortoise. FIG. 9b shows graphically the paradox in 2D space.

As shown in FIG. 9a if Achilles starts at xₛ, and moves at constant speed \dot{x}ₛ, it will reach (other than what the paradoxon claims) a tortoise at position xₚ with 1D speed \dot{x}ₚ at the time t where

xₛ+t\dot{x}ₛ=xₚ+t\dot{x}ₚ

which occurs at

$$t = \frac{{x}_{s} - {x}_{p}}{{\dot{x}}_{s} - {\dot{x}}_{p}} .$$

The same holds for a rolling scan (Achilles) catching up with a vertex (tortoise). In the perceptual rasterization pipeline the rolling scan moves in image space, while the primitive moves in a 2D projective space (horizontal x component and projective coordinate w) from spatial position x with speed \dot{x} and projective position with speed \dot{w}. This can be stated as

$${x}_{s} + t {\dot{x}}_{s} = \frac{{x}_{p} + t {\dot{x}}_{p}}{{w}_{p} + t {\dot{w}}_{p}} ,$$

which is a rational polynomial with a unique positive solution

$$t = - \frac{( \sqrt{4 {x}_{s} {\dot{w}}_{p} + {\dot{x}}_{s}^{2} - 2 {\dot{x}}_{s} {w}_{p} + {w}_{p}^{2}} - {\dot{x}}_{s} + {w}_{p} )}{2 {\dot{w}}_{p}} .$$

To produce the final bounds, the time tᵢ, and the 2D position xᵢ at this time, is computed for each of the six vertices of the space-time triangle. The convex hull of the xᵢ is the final bounding geometry.

The above process produces tighter bounds at an increase in computational cost.

Joint Foveated-Rolling Bounds

As stated above the perceptual rasterization pipeline may work on the basis of one of foveation and rolling or both. A joint approach for rolling and foveation operates similarly to the foveation-only approach as described above.

To add rolling to foveation, we add the rolling transformation to q. This is shown graphically in FIG. 9.

FIG. 9 shows in three stages the joint rolling-foveation process.

In FIG. 9a) there is shown one original edge of a primitive. For ease of understanding only a single edge of the primitive is shown. FIG. 9 b) shows how the same edge is changed due to perceptual rolling process of the same edge. The actual change in the edge may vary according to the function used and is simply shown as an exemplary result. FIG. 9c) shows the same edge which has been foveated producing another curve, that is bound from the line joining its ends, adding the gray area in FIG. 9c).

Thus FIGS. 9a) to 9c) should be considered to provide an illustrative example of the joint rolling-foveation process.

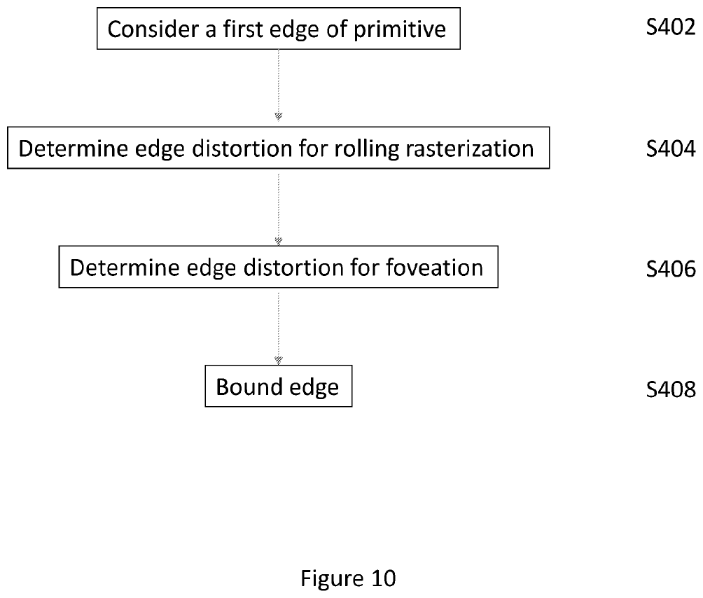

FIG. 10 is a flowchart of the joint rolling-foveation process.

At step S402 a first edge of the primitive is considered. The edge is defined by a straight line between points x₀ and x₁ in the known manner.

This is shown in FIG. 9a).

At step S404 the edge of the primitive is transformed due to the rolling rasterization process. The process is as described with reference to FIG. 6.

The rolling rasterization process results in the end of the edge being defined as p(x₀) and p(x₁). The edge, as shown graphically in FIG. 9b) is curved.

At step S406 the edge, as transformed at step S404, is further transformed due to the foveation process. Therefore at step S406 the edge as defined with ends p(x₀) and p(xᵢ) is transformed. This results in the edge having ends as qp(x₀) and qp(x₁). The process is as described with reference to FIG. 5.

FIG. 9c) shows the resultant edge. As is shown the shape of the edge is further changed.

At step S408 the edge, as defined by points as qp(x₀) and qp(x₁) and the shape, as shown in FIG. 9c) is bounded.

Let x₀ and x₁ be the original world coordinates of that edge the new edge functions are therefore

ηₛ(s)=(Q(x₀)+s(Q(x₁)−Q(x₀)) and η_{c}(s)=Q(x₀+s(x₁−x₀))

where Q is the joint action of rolling and foveation Q(x)∈ [symbol] ³→ [symbol] ²:Q(x)=q( [symbol] ((x,t)). The time t can be found using the equation for tin the discussion of Zenon hull.

Shadow Maps

In image rendering, shadow mapping is a known concept used to add shadows to 3-D graphics in the form of shadow maps or reflective shadow maps. The above described processes for foveated rasterization are not limited to the rasterization of camera images but may also be to rasterize shadow maps, or reflective shadow maps.

Various methods are known to the skilled person for creating shadow maps (for example Lance Williams, Casting curved shadows on curved surfaces, Proceedings of the 5th annual conference on Computer graphics and interactive techniques, p. 270-274, Aug. 23-25, 1978, the contents of which are incorporated by reference), and creating reflective shadow maps (for example Dachsbacher, Carsten and Stamminger, Marc, Reflective Shadow Maps, Proceedings of the 2005 Symposium on Interactive 3D Graphics and Games 2015, the contents of which are incorporated by reference).

At step S502 the gaze position, or foveation point, is determined.

The process at step S502 occurs as described with reference to FIG. 5, step S202,

The gaze position determined at step S202 is a 2D image location which also uniquely maps to a 3D position when deprojected.

Accordingly, at step S504 the gaze position is deprojected using the pixel depth information of the pixels at the gaze position. Deprojecting based on pixel depth is a known technique in the art.

Therefore at step S504 the process returns a 3D, world space, position.

At step S506, the world space position, as determined at step S504, is reprojected into light space. The projecting of the world space position into light space occurs in a known manner.

The projected light space position then defines a new gaze position for foveated rendering of the rasterized shadow map. As described with reference to the process described in FIG. 2 the shadow map may then subsequently rendered to produce a foveated image using the light space position as determined at step S506 as the gaze position.

Similarly for reflective shadow map a foveated reflective shadow map may be created using the light space position as determined at step S506 as the gaze position.

At step S508 the foveated rasterized shadow map, or foveated reflective shadow map, is rendered utilising the light space location determined at step S506 as the gaze position.

The resulting shadow maps provide refined shadow fidelity in areas the user is looking at i.e.

the gaze position as determined in the manner described above. Similarly higher-quality reflective shadow maps are produced by indirect illumination where the user is foveating (as determined at step S506).

The approaches described herein allow for an effective perceptual rasterization pipeline. Such an approach is particularly effective for head mounted displays where the extended field of view of the display, and the variations in human eye resolution mean that variations in the display of the image can result in a reduction in computational requirement without a perceived drop in quality to the end user. Similarly the process is effective for augmented reality displays where similar considerations exist. The process is also particularly effective for mobile telephones and mobile telephone applications, where due to the rolling nature of the display the rolling rasterization can improve the end user's perception of the content being displayed.

1. A method for rasterizing part of an image for a display, the image comprising one or more primitives, the method comprising for a first primitive in the image:
calculating a distortion of the primitive, said distortion dependent on a determination of how the primitive will be perceived by a user when displayed on a display;
distorting the primitive based on the calculation of the distortion to define a distorted primitive;
defining a new primitive to be rendered by:
bounding the distorted primitive with a polygon; and
defining the new primitive based on an intersection of pixels from both the first primitive and the polygon of the distorted primitive.

2. The method of claim 1 further comprising the step of rasterizing the new primitive on the display.

3. The method of claim 1 wherein the calculation of the distortion is based in part on the perceived foveation of the image by the user.

4. The method of claim 3 wherein the method further comprises:
determining a gaze position for a user's eye;
determining a location of the primitive relative to the gaze position and calculating the distortion of the primitive based on the location of the primitive relative to the gaze position.

5. The method of claim 4 wherein the resolution of pixels which form the first primitive is increased towards a fixation point and decreased away from the gaze position.

6. The method of claim 4 wherein the distortion of the primitive comprises magnifying, or demagnifying, pixels which form the first primitive.

7. The method of claim 3 wherein the bounding of the distorted primitive comprises the steps of:
for each of a plurality of edges of the original primitive defining a bounding edge parallel to the original edge of the primitive;
defining a maximum displacement from the original edge of the primitive to a corresponding edge of the distorted primitive;
defining the bounding edge at the maximum displacement and joining each defined bounding edge to define the bounded distorted primitive.

8. The method of claim 3 wherein the bounding of the distorted primitive comprises the steps of:
for each of a plurality of edges of the original primitive determining resultant vertices of the edge as a result of the foveation-based distortion and defining a bounding edge between the resultant vertices;
defining a maximum displacement from bounding edge between the resultant vertices to a corresponding edge of the distorted primitive;
defining the bounding edge at the maximum displacement and joining each defined bounding edge to define the bounded distorted primitive.

9. The method of claim 1 wherein the calculation of the distortion is based in part on motion of the primitive as a result of the time taken to render a display.

10. The method of claim 9 further comprising the steps of, for the first primitive:
determining for a plurality of vertices of the primitive a first position at a first time;
determining for a plurality of vertices of the primitive a second position at a second time; and
determining the distortion of the first primitive based on the motion of the vertices between the first and second time.

11. The method of claim 10 wherein the first time is a start time at which the primitive is first rendered and the second time is an end time at which the primitive is rendered.

12. The method of claim 11 wherein the motion of the vertices between the first and second position is linearly interpolated.

13. The method of claim 12 wherein the step of distorting the primitive further comprises:
bounding the distorted primitive with a polygon based on the position of the plurality of vertices at the first and second time.

14. The method of claim 13 wherein the bounding is based on defining a bounding box for a plurality of vertices.

15. The method of claim 13 wherein the bounding of the distorted primitive is based on a convex hull bounding.

16. The method of claim 14 wherein the bounding further comprises;
determining a maximum time a pixel is displayed;
defining the second time as the maximum time the pixel is displayed; and
bounding a convex hull over a defined time interval.

17. The method of claim 3, wherein the bounding of the distorted primitive comprises the steps of for each of a plurality of edges of the primitive:
defining a distortion to the edge due to motion of primitive to create a rolling edge;
defining a distortion to the rolling edge due to the distortion of the foveation of the image to define a joint rolling foveated edge;
bounding the joint rolling foveated edges to define the distorted primitive.

18. The method of claim 1 further comprising the steps of:
determining a gaze position for a user's eye;
deprojecting the gaze position, based on pixel depth of one or more pixels at the gaze position to define a world space position; and
projecting the world space position into light space and rendering a shadow map, or reflective shadow map, at the projected position.

19. A system for rasterizing part of an image on a display, the system comprising:
a display for rendering an image;
a processor; and
memory storing computer readable instructions that, when executed by the processor, configure the system to perform a method for rasterizing part of an image for the display, the image comprising one or more primitives, the method comprising for a first primitive in the image:
calculating a distortion of the primitive, said distortion dependent on a determination of how the primitive will be perceived by a user when displayed on a display;
distorting the primitive based on the calculation of the distortion to define a distorted primitive; and
defining a new primitive to be rendered by:
bounding the distorted primitive with a polygon, and
defining the new primitive based on an intersection of pixels from both the first primitive and the polygon of the distorted primitive.

20. The system of claim 19 further comprising an eye tracking device configured to determine a gaze position of a user's eye.

21. (canceled)
